(19) United States
(12) Patent Application Publication
(10) Pub. No.: US 2024/0302853 A1
(43) Pub. Date: Sep. 12, 2024

(54) CURRENT-GENERATION CIRCUITRY

(71) Applicant: Nordic Semiconductor ASA, Trondheim (NO)

(72) Inventors: Dominik PRZYBOROWSKI, Trondheim (NO); Vimesha SAMARASEKARA, Oulu (FI)

(73) Assignee: Nordic Semiconductor ASA, Trondheim (NO)

(21) Appl. No.: 18/597,509

(22) Filed: Mar. 6, 2024

(30) Foreign Application Priority Data
Mar. 9, 2023 (GB) 2303483.8

(51) Int. Cl. G05F 1/567

(52) U.S. Cl. CPC G05F 1/567

(57) ABSTRACT

A circuit portion for generating a current that is proportional to absolute temperature comprises first and second bipolar-junction transistors (BJTs) arranged to present a voltage difference between the emitter of the first BJT and the emitter of the second BJT that is proportional to absolute temperature. Circuitry is arranged to generate an output current in dependence on this voltage difference, wherein the output current is proportional to absolute temperature. Adjustment circuitry is electrically coupled to the base of the second BJT to sink current away from this base such that a temperature coefficient of the output current is at least partly determined by the adjustment circuitry.

### CROSS REFERENCE TO RELATED APPLICATION

This application claims priority from Great Britain Application No. 2303483.8, filed Mar. 9, 2023, which application is incorporated herein by reference in its entirety.

### TECHNICAL FIELD

This invention relates to circuitry for generating a current that is proportional to absolute temperature.

### BACKGROUND

Large-scale integrated circuits typically contain large numbers of metal-oxide-semiconductor (MOS) field-effect transistors (MOSFETs). The behaviour of such transistors, such as their transconductance, have a strong temperature dependency. It can be highly desirable to compensate for this temperature-dependent behaviour, especially in certain circuits such as amplifiers. Such compensation can be applied using a biasing current that is proportional to absolute temperature (PTAT). Such a PTAT biasing current can be generated using a bandgap reference circuit, e.g. from a voltage difference between p-n semiconductor junctions of a pair of bipolar-junction transistors (BJT) that are operating at different current densities. They can be highly accurate due to the physical principles on which they are based.

While such circuits can generate a PTAT current that can be used to compensate for MOS parameter variation with some success, the compensation thus obtained is not generally optimal as it does not account for the characteristics of the particular MOS (e.g. CMOS) type and/or process being used.

Embodiments of the present invention seek to provide a circuit design that can be used to generate a tuned PTAT current.

### SUMMARY OF THE INVENTION

From a first aspect, the invention provides a circuit portion for generating a current that is proportional to absolute temperature, the circuit portion comprising:
a first bipolar-junction transistor (BJT) and a second BJT arranged to present a voltage difference between an emitter of the first BJT and an emitter of the second BJT that is proportional to absolute temperature;
circuitry arranged to generate an output current in dependence on the voltage difference between the emitter of the first BJT and the emitter of the second BJT, wherein the output current is proportional to absolute temperature; and
adjustment circuitry electrically coupled to a base of the second BJT to sink current away from the base of the second BJT such that a temperature coefficient of the output current is at least partly determined by the adjustment circuitry.

Thus it will be seen that, in accordance with embodiments of the invention, the electrical output current has a temperature coefficient that can be tuned based on the configuration of the adjustment circuitry. By contrast, the temperature coefficient of a conventional BJT-based bandgap-generated PTAT current is always equal to approximately 1/T₀, where T₀ is room temperature in Kelvin (i.e. 1/294K≈3400 ppm/K). The present circuit design instead allows the temperature coefficient to be adapted to a particular use case, such as for compensating for the temperature-dependent behaviour of a particular MOS type and process.

In particular, the temperature coefficient may have a value other than 3400 ppm/K. In some embodiments, the temperature coefficient is, or can be set to, less than 3000 or 2500 ppm/K or greater than 4000 or 5000 ppm/K. As explained in more detail below, the temperature coefficient may be fixed or may be adjustable in use.

In some embodiments the first BJT and/or second BJT could be diode-connected (i.e. with base and collector shorted), but this is not the case in other embodiments, as described herein.

The first and second BJTs may be arranged in any appropriate way for presenting a temperature-dependent voltage difference between their outputs. The bases of the first and second BJTs may be electrically coupled together so as to be at a same voltage.

In preferred embodiments, the first BJT has a different emitter area from the second BJT. The circuit portion may be arranged to provide a current to the collector of the second BJT that is equal to a current provided by the circuit portion to the collector of the first BJT. It may comprise a pair of “supply” transistors, of equal dimension, for supplying equal current to each of the collectors. These supply transistors may be MOS transistors, e.g. PMOS transistors. The gates of the supply transistors may be electrically coupled so as to be at a same voltage.

In other, less-preferred embodiments, the first BJT may have a same area as the second BJT and the circuit portion may be arranged to provide a current to the collector of the second BJT that is different from a current provided to the collector of the first BJT.

In a first set of embodiments, the adjustment circuitry may be fixed and the temperature coefficient may be constant. The adjustment circuitry may be such that the circuit portion can be implemented with a desired temperature coefficient selected from a set of possible values (e.g. selected by a designer), based on a predetermined circuit design, by setting one or more parameters of the adjustment circuitry to a respective corresponding value. The parameter may be a value of a resistor and/or a ratio of one or more current mirrors.

In a second set of embodiments, the adjustment circuitry may be configurable in use and the temperature coefficient may be variable—e.g. by software executing on a device incorporating the circuit portion and/or in response to a value stored in a register of a register interface provided by the adjustment circuitry. The temperature coefficient may be adjustable to any value within a set of possible values.

In both sets of embodiments, the set of possible values may have a smallest value equal to 2000 ppm/K or less. It may have a highest value equal to 7000 ppm/K or more.

The adjustment circuitry may provide one or more sink paths arranged in parallel to an electrical path containing the base-emitter junction of the second BJT. Each sink path may be coupled to the base of the second BJT so as to be at a same voltage as the base of the second BJT. The circuit portion may be arranged to sink current away from the base of the second BJT, but not to sink as much, or any, current away from the base of the first BJT.

The adjustment circuitry may provide such a sink path comprising a resistor. The sink path may be coupled to the base of the second BJT and may additionally be coupled to the emitter of the second BJT such that the resistor is connected in parallel to (e.g. across) the base-emitter junction of the second BJT. It may shunt the base-emitter junction of the second BJT. More generally, the adjustment circuitry may comprise a shunt resistor that is arranged to shunt the base-emitter junction of the second BJT such that the temperature coefficient of the output current depends at least in part on the resistance of the shunt resistor. The resistor on the sink path, or shunt resistor, may have a fixed or variable resistance. In either case, the value of the resistor may be set to an appropriate value to provide a desired temperature coefficient for the output current. The resistor may be a single circuit element, or it may comprise a set of elements, e.g. a bank of resistors, optionally connected with switches for controlling which of the bank of resistors are connected to the sink path.

The adjustment circuitry may additionally or alternatively provide such a sink path (e.g. a different sink path) comprising a first transistor, which may be a MOS transistor—e.g. an NMOS transistor. The first transistor may be part of a current source. It may be a coupled to a second transistor to form a current mirror. The second transistor may be a MOS transistor—e.g. an NMOS transistor. This “sink” current mirror may have a non-unity current transfer ratio. The current transfer ratio may have a fixed or variable value. In either case, the value of the ratio may be set to an appropriate value to provide a desired temperature coefficient for the output current. Each of these transistors may be a respective single transistor; however, in some embodiments one or both may comprise a respective set of elements, e.g. a bank of transistors, optionally connected with switches for controlling which of the bank of transistors are connected to the sink path, so as to adjust the effective area of the transistor.

The circuit portion may comprise a current source arranged to supply a biasing current to the base the first BJT and a biasing current to the base of the second BJT. The current source may comprise a current mirror. It may comprise first and second MOS transistors, which may be PMOS transistors. This “biasing” current mirror may have a non-unity current transfer ratio. The temperature coefficient of the output current may depend at least in part the current transfer ratio of the biasing current mirror. Where a sink current mirror is also provided, the temperature coefficient may depend at least in part on a ratio of the current transfer ratio of the biasing current mirror to the current transfer ratio of the sink current mirror. The value of this ratio of ratios may be set to an appropriate value to provide a desired temperature coefficient for the output current.

The circuitry for generating the PTAT output current may comprise a resistance (e.g. one or more resistors) electrically coupled between the emitter of the first BJT and the emitter of the second BJT. The circuitry may provide a first resistance between the emitter of the first BJT and a ground reference potential, and a second resistance, larger than the first resistance, between the emitter of the second BJT and the ground reference potential.

The circuitry for generating the PTAT output current may comprise an output transistor for scaling an absolute value of the output current, e.g. in dependence on a dimension ratio of the output transistor to a transistor of the biasing current mirror.

The circuit portion may be a complete electrical circuit (e.g. including a power supply), or may be a portion of, or for inclusion in, a larger electrical circuit. The circuit portion may be an integrated circuit portion, e.g. being integrated on a semiconductor substrate, optionally electrically coupled to one or more further circuit portions.

From a second aspect, the invention provides an electronic device comprise the circuit portion. The electronic device may be a semiconductor device such an integrated circuit. It may a silicon chip. It may be a system on chip (SoC). It may comprise one or more components (e.g. further circuit portions) arranged to be controlled in dependence on the output current. It may comprise circuitry configured to use the output current to apply temperature compensation for the component (i.e. to compensate for changes in behaviour of the component due to changes in a temperature of the device). The component may comprise one or more MOSFETs. The component may be an amplifier, such as a low-noise amplifier (LNA) or a power amplifier (PA), e.g. as part of a radio device.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a circuit diagram of a circuit portion of conventional design for generating a PTAT output current;

FIG. 2 is a circuit diagram of a circuit portion embodying the invention for generating a PTAT output current;

FIG. 3 is a graph of predicted temperature coefficient of the output current against a configurable current-ratio parameter for two embodiments having different BJT efficiencies; and

FIG. 4 is a graph of simulated normalized output current against temperature for embodiments having different values of the current-ratio parameter.

### DETAILED DESCRIPTION

Bandgap voltage references use the inherent physical properties of p-n junctions to generate a temperature-independent voltage. The same principle can also be used to generate a current that is proportional to absolute temperature (PTAT). Such a current can be useful as a biasing control to compensate for the temperature dependency of transistor parameters, e.g. for compensating components such as MOSFET-based integrated-circuit amplifiers.

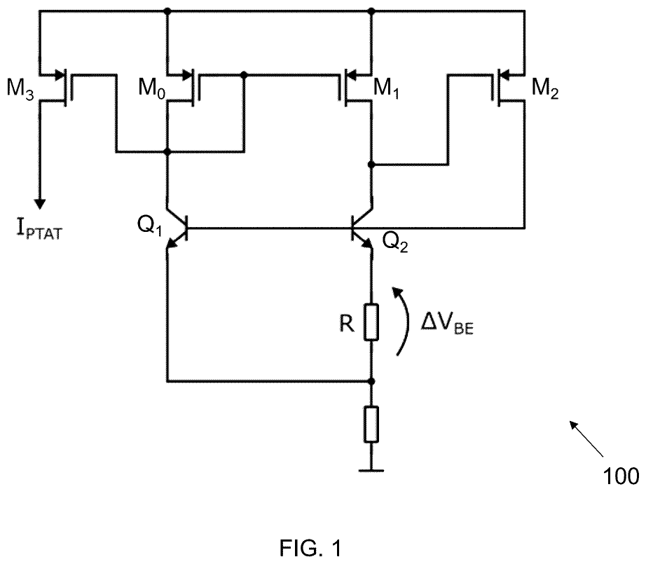

FIG. 1 shows a bandgap-based circuit portion 100 of conventional design that can generate an output current I_{PTAT} that is proportional to absolute temperature (PTAT). The output current I_{PTAT} has a fixed temperature coefficient of approximately 3400 ppm/K.

The generated current is equal to

$${I}_{PTAT} = \frac{{ΔV}_{BE}}{R} = ln ( N ) \frac{{V}_{t}}{R} ,$$

where:
ΔV_{BE} is the difference in voltages across the respective base-emitter junctions of the two bipolar transistors Q₁ and Q₂ (i.e. the difference between the emitter voltages of Q₁ and Q₂, since their bases are at the same voltage);
R is the resistance between the emitters;
N is the area ratio between the transistors; and
Vₜ=kT/q is the thermal voltage, where k is a Boltzmann constant, q is an elementary charge, and T is the absolute temperature (i.e. of the circuit portion, and of Q₁ and Q₂ in particular).

The temperature coefficient (TC) of the I_{PTAT} current generated by the circuit of FIG. 1 is related to its value at room temperature (T₀=20° C.) as follows:

$$TC = \frac{1}{{I}_{PTAT} ( {T}_{0} )} \frac{\partial {I}_{PTAT}}{\partial T} = \frac{1}{{T}_{0}} \approx 3411.2 ( \frac{ppm}{K} ) .$$

This value of TC is constant and perfectly compensates the temperature effects on bipolar junction transistors. However, due to the different nature of MOS transistors, parameters of MOS transistors such as transconductance depend on current density or carrier mobility, the temperature dependency of which varies between different CMOS process. In order to properly compensate for temperature-induced changes to such parameters, a TC anywhere in the range 2000-6000 ppm/K may be required, depending on the particular CMOS type and process being used.

Therefore, it is desirable to have a circuit design that allows the TC of a PTAT current to be tuned (either fixedly at the design stage, or dynamically in use).

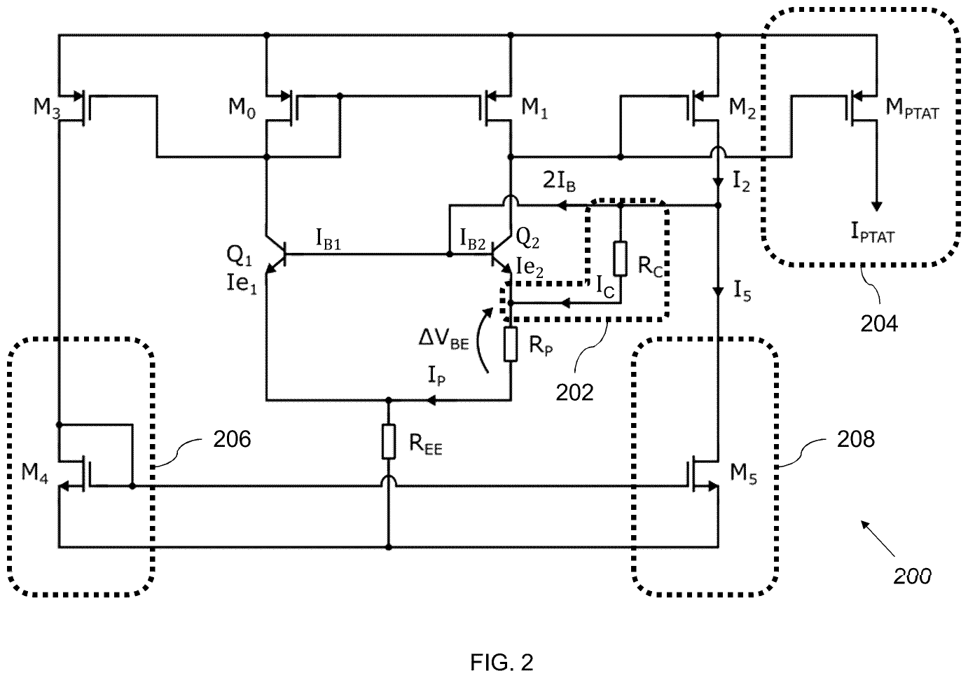

FIG. 2 shows a novel circuit 200 for generating a PTAT output current, I_{PTAT}, wherein the circuit 200 has a configurable temperature coefficient (TC).

The new PTAT current generator 200 is based around a CMOS implementation of a Brokaw bandgap circuit, similar to the circuit 100 in FIG. 1, but with additional adjustment circuitry added to enable the TC to be tuned to a desired value. The main additions are indicated within the four dashed-line blocks 202, 204, 206, 208.

In particular, the enhanced circuit portion 200 contains:
a resistor R_{C} (shown in block 202) that shunts the base-emitter junction of the second bipolar transistor Q₂ in the branch of ΔV_{BE} generator; and
an NMOS current source, comprising a pair of NMOS transistors M₄ and M₅ (shown in blocks 206, 208) arranged as a current mirror, biased from the current mirror formed by PMOS transistors M₃ and M₀. This NMOS “sink” current mirror reduces the PTAT current generated on the second bipolar transistor Q₂, and also on the first bipolar transistor Q₁, by sinking current from the PMOS current source M₂ that biases the bases of both the bipolar transistors Q₁, Q₂. It increases the current of M₂, because, for a given emitter current, a BJT has an exactly specified base current and base-emitter voltage (and vice versa), so the currents I_{C} and I_{B} are given, and the current of the current source M₂ is the sum of the current flowing into the BJTs Q₁, Q₂ and the current sunk due to M₅.

The circuit 200 also contains one more PMOS transistor, M_{PTAT}, than the conventional circuit 100 in FIG. 1, which can be set to scale the absolute value of the output current I_{PTAT}.

In a classic bandgap reference circuit, a PTAT current is generated by the difference between two p-n junction voltage drops on a resistor R. This difference, ΔV_{BE}, is equal to Vₜ·ln(N), where Vₜ=kT/q is thermal voltage and N is a ratio of the two p-n junctions, and is linear with temperature with slope equal to k/q. As already noted above, this results in the generation of current with constant TC set to 1/T₀ (˜3400 ppm/K).

The circuit 200 presented in FIG. 2 introduces extra degrees of freedom to control the relative weightings of a PTAT current, I_{P}, and a CTAT (Complementary to Absolute Temperature) current, I_{C}, that are summed at a summation node. The summation can be seen as occurring at the emitter of Q₂ (the current I_{C} being summed negatively, due to Kirchoff's Current Law, such that Iₑ₂=I_{P}−I_{C}). However, it may also be regarded as occurring at the drain of M₂, because the current I₅ is a scaled version this I_{P}−I_{C} summed current.

In other words, the emitter current, Iₑ₂, of Q₂ is I_{P}−I_{C}, and is the same as emitter current, Iₑ₁, of Q₁, which is next scaled by current mirrors as I₅, and is also scaled by the ß of the BJTs Q₁, Q₂ to a current I_{B}. This results in the following summation at the drain of M₂: I₂=2I_{B}+I_{C}+I₅.

The current I_{C} is complementary to temperature because it is generated by the base-emitter voltage of Q₂ dropped on the resistor R_{C}, and the base-emitter voltage decreases with temperature. Meanwhile, the current flowing through resistors R_{EE}, R_{P} and transistors Q₁ and Q₂ has strong positive temperature coefficient.

Thus, circuit designs as disclosed herein can allow a designer to generate and tune the temperature coefficient of the PTAT output current, I_{PTAT}, to a desired value. This optimised I_{PTAT} current may be beneficially used to provide better temperature compensation to other circuitry within a device, e.g. other components, such as a MOS-based amplifier, within a SoC (System on Chip) that contains the circuit portion 200.

Some embodiments may implement the circuit 200 using fixed transistors and resistors such that the TC is fixed to a desired value.

Other embodiments may implement the resistor R_{C} using a switchable bank of resistors whose overall resistance can be varied in use, and/or may implement one or more of the MOS transistors, such as M₄ or M₅, using a switchable bank of transistors whose overall effective area can be varied. This variation may be controlled by digital logic coupled to the circuit 200. This may allow the TC to be adjusted by software executing on a device incorporating the circuit 200.

Considering the circuit 200 in greater detail, it will be seen that the output current I_{PTAT} is proportional to the drain current of the transistor M₂. Its absolute value can thus be scaled by appropriately configuring the dimension ratio between M_{PTAT} and M₂ (either fixedly at the design stage, or in use if the effective area of one or both of these transistors can be changed during operation).

The resistor R_{EE}, which connects the emitter of the first BJT Q₁ to ground, does not affect the temperature coefficient or output current I_{PTAT}, but can be chosen to obtain a desired voltage level, in situations where it is useful for the circuit portion 200 to output a voltage level also. However, R_{EE} is not essential and may be omitted (i.e. having zero resistance) in some embodiments.

The following mathematical analysis shows how the TC of the circuit 200 can be configured to a desired value. It focuses particularly on the value of the current I₂ as labelled in FIG. 2.

The current mirror M₀−M₁ has unity ratio, so the emitter currents of the transistors Q₁ and Q₂ are equal, i.e. Iₑ₁=Iₑ₂=Iₑ. Therefore, the respective base currents into Q₁ and Q₂ are also equal, i.e. I_{B1}=I_{B2}=I_{B}.

Thus

$${I}_{2} = 2 {I}_{B} + {I}_{C} + {I}_{5} ,$$

$${I}_{B} = \frac{{I}_{e}}{β + 1} ,$$

$${I}_{C} = \frac{{V}_{BE}}{{R}_{C}} ,$$

$${I}_{5} = {k}_{1} {k}_{2} {I}_{e} = {KI}_{e} ,$$

where:
β is current gain parameter of the BJTs Q₁ and Q₂;
k₁ is the current ratio of the current mirror M₃−M₀; and
k₂ is the current ratio of the “sink” current mirror M₅−M₄.

It can also be seen that:

$${I}_{P} = \frac{Δ {V}_{BE}}{{R}_{P}} ,$$

$$Δ {V}_{BE} = {V}_{t} ln ( N ) = \frac{kT}{q} ln ( N ) ,$$

$${I}_{B} = \frac{{I}_{e}}{β + 1} = \frac{{I}_{P} - {I}_{C}}{β + 1} = \frac{1}{β + 1} ( \frac{Δ {V}_{BE}}{{R}_{P}} - \frac{{V}_{BE}}{{R}_{C}} ) .$$

The resulting I₂ current can be written as:

$${I}_{2} = \frac{2}{β + 1} ( \frac{{V}_{t} ln ( N )}{{R}_{P}} - \frac{{V}_{BE}}{{R}_{C}} ) + \frac{{V}_{BE}}{{R}_{C}} + K ( \frac{{V}_{t} ln ( N )}{{R}_{P}} - \frac{{V}_{BE}}{{R}_{C}} )$$

$${I}_{2} = \frac{{V}_{t} ln ( N )}{{R}_{P}} \frac{( β + 1 ) K + 2}{β + 1} + \frac{{V}_{BE}}{{R}_{C}} \frac{β - 1 - K ( β + 1 )}{β + 1} .$$

Finally, the temperature dependence of this current can be written as:

$$\frac{\partial {I}_{2}}{\partial T} = \frac{1}{{R}_{P}} \frac{k}{q} ln ( N ) \frac{( β + 1 ) K + 2}{β + 1} + \frac{1}{{R}_{C}} \frac{\partial {V}_{BE}}{\partial T} \frac{β - 1 - K ( β + 1 )}{β + 1} .$$

Since k/q is equal to 86.14 μV/K and ∂V_{BE}/∂T is approximately equal to −1.78 mV/K:

$$\frac{\partial {I}_{2}}{\partial T} = \frac{86.14 . μ . ln ( N )}{{R}_{P}} \frac{( β + 1 ) K + 2}{β + 1} - \frac{1.78 m}{{R}_{C}} \frac{β - 1 - K ( β + 1 )}{β + 1} .$$

It is apparent from this relationship that any desirable temperature coefficient (TC) of the PTAT current, I_{PTAT}, which is simply a scaled version of I₂, can be obtained by appropriately configuring the values of R_{C} and K, where K is determined by the ratio of the current transfer ratios of the two current mirrors M₃−M₀ and M₅−M₄.

If dynamic adjustment of the TC is required, depending the range of adjustment required, it may be sufficient for only R_{C} to be adjustable in use, or for only K to be adjustable in use, but in some embodiments both may be adjustable.

Although the adjustment circuitry in this example circuit 200 has both a shunt resistor R_{C} and a sink current mirror M₄, M₅, some embodiments may potentially omit the shunt resistor R_{C} (i.e. such that R_{C} can be considered infinite in the equations above) or omit the sink current mirror M₄, M₅. This may reduce the range of values that TC can practicably be set to, but may still provide advantages over the conventional non-tunable TC approach shown in FIG. 1.

The circuit portion 200 may be integrated into a semiconductor device, e.g. with all of its components being fabricated on a same semiconductor substrate, optionally along with one or more further components arranged to receive the output current I_{PTAT} and to use it to provide temperature compensation.

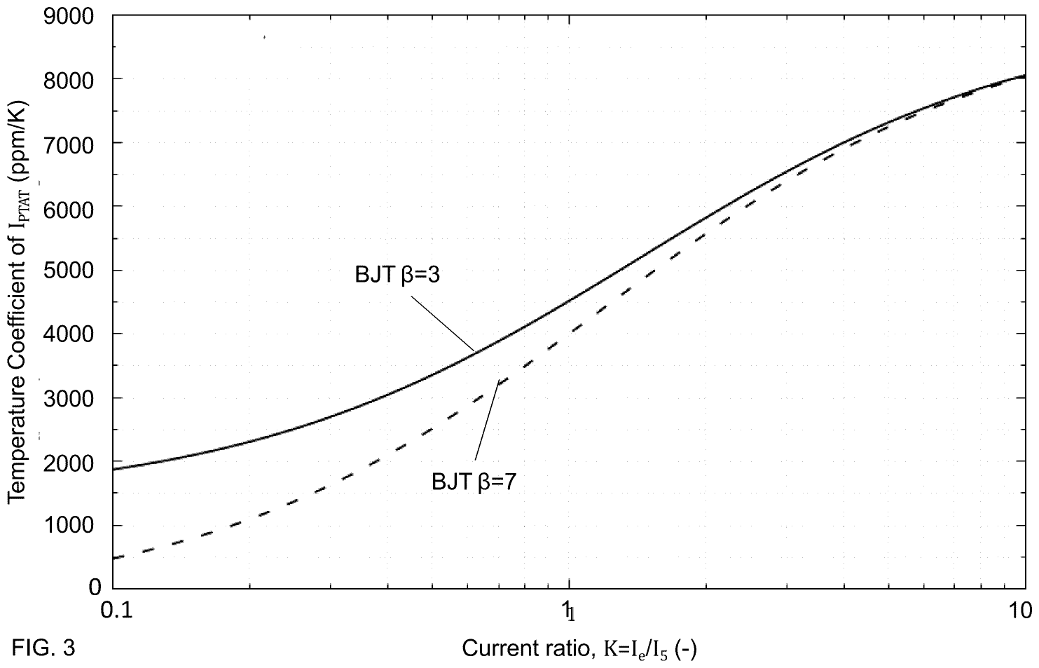

FIG. 3 shows an example of mathematically-predicted PTAT temperature coefficient against the ratio of current mirror ratios, K=k₁/k₂=Iₑ/I₅, for two typical values of current gain β in CMOS process that the BJTs Q₁ and Q₂ might have in some implementations. The predicted TC is based on the equations above, and this shows that, in a real implementation, the TC may be set to values between 2000 and 8000 ppm/K for β=3, and between 500 and 8000 ppm/K for β=7, simply by appropriately setting the relative dimensions of the MOS transistors.

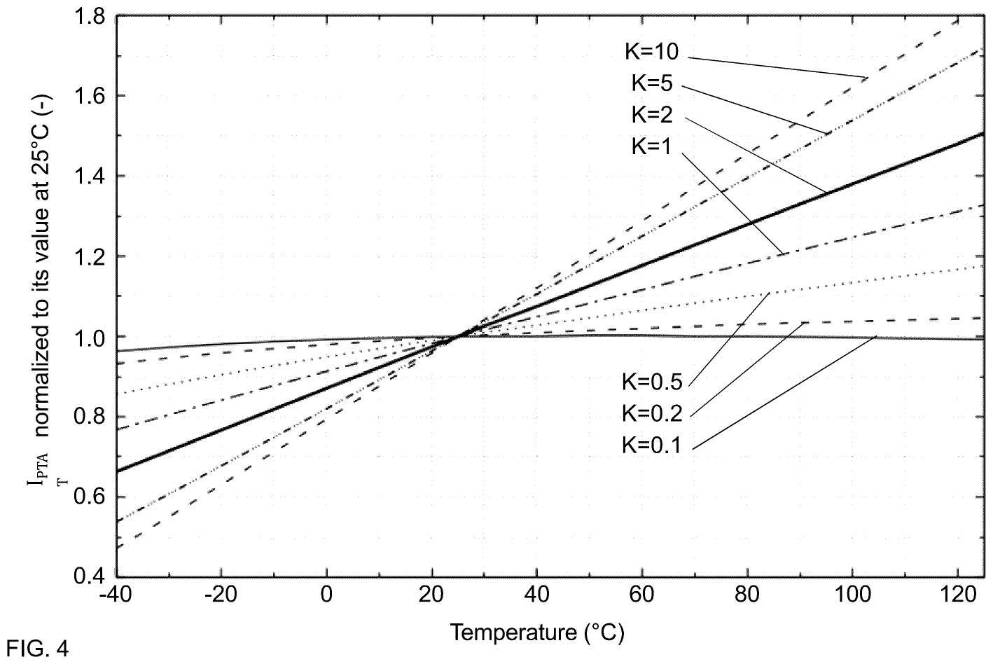

FIG. 4 shows the simulated temperature dependency of the PTAT output current, I_{PTAT}, normalised to 25° C., for various values of current mirror ratio K between 0.1 and 10. These transistor-level simulations demonstrate the effectiveness of the design principles exemplified in the circuit 200.

It will be appreciated by those skilled in the art that the invention has been illustrated by describing one or more specific embodiments thereof, but is not limited to these embodiments; many variations and modifications are possible, within the spirit and scope of the disclosure.

We claim:

1. A circuit portion for generating a current that is proportional to absolute temperature, the circuit portion comprising:
a first bipolar-junction transistor and a second bipolar-junction transistor arranged to present a voltage difference between an emitter of the first bipolar-junction transistor and an emitter of the second bipolar-junction transistor that is proportional to absolute temperature;
circuitry arranged to generate an output current in dependence on the voltage difference between the emitter of the first bipolar-junction transistor and the emitter of the second bipolar-junction transistor, wherein the output current is proportional to absolute temperature; and
adjustment circuitry electrically coupled to a base of the second bipolar-junction transistor to sink current away from the base of the second bipolar-junction transistor such that a temperature coefficient of the output current is at least partly determined by the adjustment circuitry.

2. The circuit portion of claim 1, wherein the temperature coefficient of the output current is, or can be set to be, less than 3000 ppm/K.

3. The circuit portion of claim 1, wherein the temperature coefficient of the output current is, or can be set to be, greater than 4000 ppm/K.

4. The circuit portion of claim 1, wherein the adjustment circuitry is fixed and the temperature coefficient is constant over time.

5. The circuit portion of claim 1, wherein the adjustment circuitry is configurable in use so as to enable the temperature coefficient to be varied in use.

6. The circuit portion of claim 1, wherein the first bipolar-junction transistor has a different emitter area from the second bipolar-junction transistor, and wherein the circuit portion is arranged to provide a current to the collector of the second bipolar-junction transistor that is equal to a current provided by the circuit portion to the collector of the first bipolar-junction transistor.

7. The circuit portion of claim 1, comprising a current source, comprising a current mirror, arranged to supply a biasing current to the base the first bipolar-junction transistor and a biasing current to the base of the second bipolar-junction transistor.

8. The circuit portion of claim 1, wherein the adjustment circuitry comprises a shunt resistor arranged to shunt the base-emitter junction of the second bipolar-junction transistor, wherein the temperature coefficient of the output current depends at least in part on the resistance of the shunt resistor.

9. The circuit portion of claim 1, wherein the adjustment circuitry provides one or more sink paths, coupled to the base of the second bipolar-junction transistor so as to be at a same voltage as the base of the second bipolar-junction transistor, and arranged in parallel to an electrical path containing the base-emitter junction of the second bipolar-junction transistor.

10. The circuit portion of claim 1, wherein the adjustment circuitry provides a sink path comprising a resistor, the sink path being coupled to the base of the second bipolar-junction transistor and further being coupled to the emitter of the second bipolar-junction transistor such that the resistor is connected in parallel to the base-emitter junction of the second bipolar-junction transistor.

11. The circuit portion of claim 1, wherein the one or more sink paths comprises a sink path comprising a first MOS transistor, wherein the adjustment circuitry further comprises a second MOS transistor coupled to the first MOS transistor to form a sink current mirror.

12. The circuit portion of claim 11, comprising a current source, comprising a biasing current mirror, arranged to supply a biasing current to the base the first bipolar-junction transistor and a biasing current to the base of the second bipolar-junction transistor, wherein the temperature coefficient of the output current depends at least in part on a ratio of the current transfer ratio of the biasing current mirror to the current transfer ratio of the sink current mirror.

13. The circuit portion of claim 1, wherein the circuitry for generating the output current comprises a resistor electrically coupled between the emitter of the first bipolar-junction transistor and the emitter of the second bipolar-junction transistor.

14. The circuit portion of claim 13, wherein the resistor provides a first resistance between the emitter of the first bipolar-junction transistor and a ground reference, and a second resistance, different from the first resistance, between the emitter of the second bipolar-junction transistor and the ground reference.

15. The circuit portion of claim 1, wherein the circuitry for generating the output current comprises an output transistor for scaling an absolute value of the output current.

16. An electronic device comprising a circuit portion for generating a current that is proportional to absolute temperature, the circuit portion comprising:
a first bipolar-junction transistor and a second bipolar-junction transistor arranged to present a voltage difference between an emitter of the first bipolar-junction transistor and an emitter of the second bipolar-junction transistor that is proportional to absolute temperature;
circuitry arranged to generate an output current in dependence on the voltage difference between the emitter of the first bipolar-junction transistor and the emitter of the second bipolar-junction transistor, wherein the output current is proportional to absolute temperature; and
adjustment circuitry electrically coupled to a base of the second bipolar-junction transistor to sink current away from the base of the second bipolar-junction transistor such that a temperature coefficient of the output current is at least partly determined by the adjustment circuitry.

17. The electronic device of claim 16, wherein the electronic device is an integrated-circuit system on chip (SoC).

18. The electronic device of claim 16, comprising circuitry configured to use the output current to apply temperature compensation for a component of the electronic device.

19. The electronic device of claim 18, wherein the component comprises one or more MOSFETs.
